(19) United States
(12) Patent Application Publication
(10) Pub. No.: US 2018/0108902 A1
(43) Pub. Date: Apr. 19, 2018

(54) FILLING AND SEALING ENERGY STORAGE STRUCTURES, AND FABRICATION TOOLS THEREFOR

(71) Applicant: The Paper Battery Company, Inc., Troy, NY (US)

(72) Inventors: Sudhir Rajaram KULKARNI, II, Loudonville, NY (US); Renato FRIELLO, Schenectady, NY (US)

(73) Assignee: The Paper Battery Company, Inc., Troy, NY (US)

(21) Appl. No.: 15/785,738

(22) Filed: Oct. 17, 2017

Related U.S. Application Data
(60) Provisional application No. 62/408,988, filed on Oct. 17, 2016.

(51) Int. Cl. H01M 2/36

(52) U.S. Cl. CPC H01M 2/361; H01M 2220/30; H01M 2/365

(57) ABSTRACT

Methods and devices are provided for filling and sealing an energy storage device. The process includes, for instance: providing an energy storage device with an opening to an electrolyte-receiving chamber; filling the electrolyte-receiving chamber with an electrolyte; cooling the electrolyte within the electrolyte-receiving chamber; and sealing the opening while cooling the electrolyte within the electrolyte-receiving chamber.

### CROSS-REFERENCE TO RELATED APPLICATION

This application claims the benefit of U.S. provisional patent application Ser. No. 62/408,988, filed Oct. 17, 2016, which is hereby incorporated herein by reference in its entirety.

### FIELD OF THE INVENTION

The present invention relates to methods and tools for filling and sealing energy storage structures, such as supercapacitor structures.

### BACKGROUND

Mobile consumer electronic devices, such as smart phones, tablet computers, portable media devices, and portable medical devices, etc., may have many energy consuming components and subsystems, such as, for example, displays, radio transceivers, processors, and camera flash devices, etc. Each component or subsystem may have different electrical requirements, including, for instance, different operating requirements for voltage, current, power, and energy.

One of the key goals of the electronics industry is to reduce the size and weight of these electronic devices, even as functionality requirements, such as run-time, are increased. A significant portion of the size and weight of electronic devices derives from the use of single purpose materials in the construction of the electronic devices.

### SUMMARY

The shortcomings of the prior art are overcome and additional advantages are provided, in one or more aspects, through the provision of a method, which includes: providing an energy storage device with an opening to an electrolyte-receiving chamber; filling the electrolyte-receiving chamber with an electrolyte; cooling the electrolyte within the electrolyte-receiving chamber; and heat-sealing or pressure-sealing the opening while continuing to cool the electrolyte within the electrolyte-receiving chamber.

In one or more other aspects, a device for filling and sealing an energy storage device is provided which includes: one or more cooling plates for cooling an electrolyte-receiving chamber of the energy storage device; one or more heated clamps for sealing an opening placed near an edge of the energy storage device, the set of heated clamps being adjacent to and spaced apart from the cooling plates, wherein the cooling plates and the heated clamps are controlled independently of one another; and a controller for independently controlling the one or more cooling plates and the one or more heated clamps.

Additional features and advantages are realized through the techniques of the present invention. Other embodiments and aspects of the invention are described in detail herein and are considered a part of the claimed invention.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 depicts a flowchart of a method, in accordance with one or more aspects of the present invention;

FIG. 2 depicts, by way of example, an energy storage device to be filled, in accordance with one or more aspects of the present invention;

FIGS. 3-7 depict an apparatus and method for filling and sealing the energy storage device, in accordance with one or more aspects of the present invention;

FIG. 8 depicts a needle and pump assembly for filling an energy storage device, in accordance with one or more aspects of the present invention; and

FIGS. 9-12 depict a more detailed example of an embodiment of filling and sealing an energy storage device, in accordance with one or more aspects of the present invention.

FIG. 13 depicts a computer system, such as a controller, in accordance with one or more aspects of the present invention.

### DETAILED DESCRIPTION

Aspects of the present invention and certain features, advantages, and details thereof, are explained more fully below with reference to the non-limiting examples illustrated in the accompanying drawings. Descriptions of well-known materials, fabrication tools, processing techniques, etc., are omitted so as not to unnecessarily obscure the invention in detail. It should be understood, however, that the detailed description and the specific examples, while indicating aspects of the invention, are given by way of illustration only, and not by way of limitation. Various substitutions, modifications, additions, and/or arrangements, within the spirit and/or scope of the underlying inventive concepts will be apparent to those skilled in the art from this disclosure. Note further that numerous inventive aspects and features are disclosed herein, and unless inconsistent, each disclosed aspect or feature is combinable with any other disclosed aspect or feature, as desired by a particular application, for instance, to facilitate filling and sealing an energy storage structure.

Many electrolytes (aqueous and non-aqueous) used across the spectrum of energy storage devices are sensitive to sublimation and vaporization in the environments consisting of atmospheres, pressure, and temperatures necessary for construction of energy storage devices. The affinity for sublimation and vaporization of electrolytes is negatively impacted by the processing conditions of welding, sealing, and various forms of structural bonding required in the production of energy storage devices. The electrolytes (including salts+volatile solvents) used as ionic or electron charge transport media typically have a high vapor pressure and a low boiling point, for instance, a boiling point as low as 85° C. Even at room temperature the electrolyte may evaporate. This can create a formidable problem in filling and sealing these devices, as heat and pressure is required to seal these devices.

Thus, there is believed to be a commercial advantage to developing methods that minimize or do not allow for the electrolytes to evaporate during filling and sealing of the devices.

This invention uses surface contact and active thermal management to control enthalpy of sublimation and vaporization of electrolytes exposed to these required conditions. With the active thermal management described as the invention energy storage devices can be constructed with higher levels of precision allowing for greater stability of performance and extended life of the device.

This invention also allows the electrolyte to be dispensed without being chilled during dispense which can negatively affect the electrolyte concentration. By using the active thermal management invention energy storage devices can be constructed in smaller form factors as the sensitive electrolyte is isolated from the added energy required for fabrication of the device. These smaller form factors contribute to one of the primary metrics used in the energy storage industry which is power and energy density.

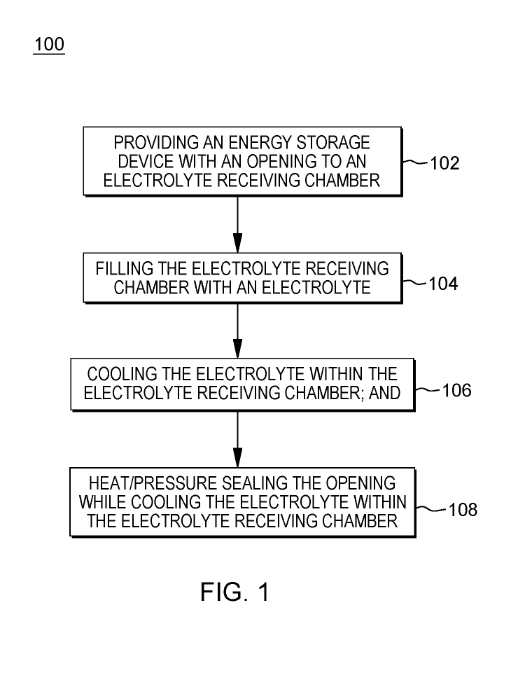

Previous attempts at filling and sealing energy storage devices have not obtained the performance possible according to embodiments of the current invention due, at least in part, to the volatility of the electrolytes utilized. In one embodiment, for instance, as depicted in FIG. 1, a method 100 is disclosed herein which includes providing an energy storage device with an opening to an electrolyte-receiving chamber 102, and filling the electrolyte-receiving chamber with an electrolyte 104. The method also including cooling the electrolyte within the electrolyte-receiving chamber 106, and heat-sealing the opening while cooling the electrolyte within the electrolyte-receiving chamber 108. The simultaneous cooling of the electrolyte and heat-sealing allow for the electrolyte to remain in a liquid state, reducing or eliminating evaporation during or caused by the heat-sealing temperatures. According to some embodiments, a controlled amount of electrolyte can be efficiently placed within the electrolyte-receiving chamber and remain there through the sealing steps. Further advantages will be apparent in light of the discussion provided herein. The purpose of this invention is to thermally manage the phase change boundary between solid, liquid and vapor conditions of an electron transport media (electrolyte) during the construction of an energy storage device. Managing the phase change allows precision application of the electrolyte during construction, predictable and stable device performance, and smaller device form factors.

Incorporated herein by reference in its entirety is U.S. patent application Ser. No. 14/215,571, entitled “Energy Storage Structures and Fabrication Methods Thereof”, which published on Sep. 25, 2014, as U.S. Patent Publication No. 2014/0287277 A1, which provides, in part, energy storage structures and fabrication methods thereof which can be utilized in embodiments of the current invention. An energy storage structure may be, for example, an ultra-capacitor, a capacitor, battery, fuel cell, any other device or structure capable of storing energy, or any combination thereof. As used herein, a “supercapacitor” is, for instance, an electrochemical capacitor that includes an electrolyte disposed between electrodes. An electrolyte is, for example, a substance, which may be a liquid, through which electricity may pass. In another example, an electrolyte may be a solid or semisolid, flowable material. One example of a supercapacitor is an electrochemical double layer capacitor (EDLC), which stores electrical energy by, for example, the separation of charge, for instance, in a double layer of ions, at the interface between the surface of a conductive electrode and an electrolyte. Another term for a supercapacitor is an ultra-capacitor.

Energy storage devices may be characterized by an energy density and a power density. The energy density (also known as the specific energy) of an energy storage device is defined as the amount of energy stored per unit mass of the device, and the power density is defined as the rate per unit mass at which energy may be transferred to or from the device. Different types of energy storage devices may be compared by comparing their respective energy densities and power densities. As one example, an activated carbon supercapacitor may have, for example one-tenth of the energy density of a conventional lithium-ion rechargeable battery, but have, for example, 10 to 100 times the power density of the conventional lithium-ion rechargeable battery.

Generally stated, these structures can include a structure including an energy storage structure. The energy storage structure includes: a first conductive sheet portion and a second conductive sheet portion separated by a permeable separator sheet, the first conductive sheet portion and the second conductive sheet portion defining, at least in part, outer walls of the energy storage structure, wherein a first surface region of the first conductive sheet portion includes a first electrode facing a first surface of the permeable separator sheet and a second surface region of the second conductive sheet portion comprises a second electrode facing a second surface of the permeable separator sheet, the first surface and the second surface of the permeable separator sheet being opposite surfaces thereof; an electrolyte receiving chamber, the electrolyte receiving chamber being defined, at least in part, by the first surface region of the first conductive sheet portion and the second surface region of the second conductive sheet portion, and the electrolyte receiving chamber including: at least one bonding border, the at least one bonding border bonding the first conductive sheet portion, the second conductive sheet portion, and the permeable separator sheet together, and forming a bordering frame around at least a portion of the first electrode and the second; and an electrolyte within the electrolyte receiving chamber, including in contact with the first electrode and the second electrode, wherein the electrolyte is capable of passing through the permeable separator sheet.

Also included by reference is an energy storage structure which is a flexible energy storage structure capable of being bent at any angle. In another implementation, the bordering frame is (or includes) an electrical insulator, the electrical insulator electrically isolating the first conductive sheet portion from the second conductive sheet portion. In a further implementation the bordering frame provides a fluid-tight seal around the electrolyte receiving chamber and is or includes a chemically resistant material, the chemically resistant material inhibiting leakage from the electrolyte receiving chamber.

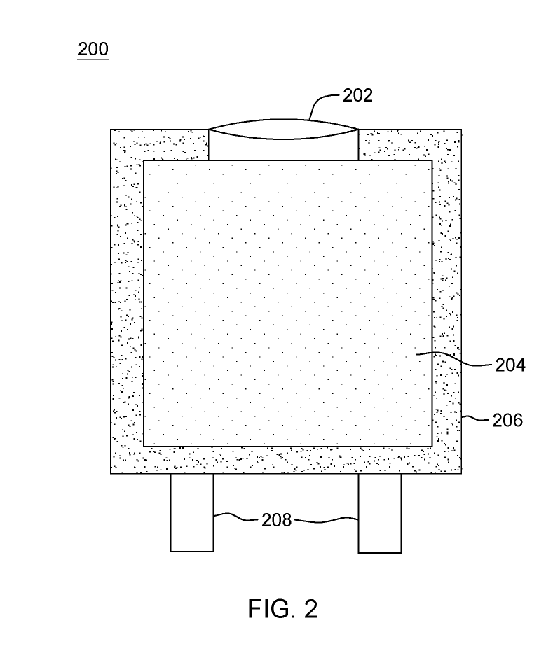

For instance, turning to FIG. 2, an energy storage device 200 is depicted before filling according to embodiments of the present invention. The energy storage device 200 includes an opening 202 to an electrolyte-receiving chamber 204, surrounded by an edge 206, which has been sealed except for opening 202, which can be approximately 18 millimeters (mm) wide. The height of the seal may be between 3 mm and 20 mm. As depicted, the energy storage device 200 may be approximately 45 mm wide and approximately 54 mm tall, but this is not intended to be limiting. The energy storage device 200 may further include a set of contacts 208. The energy storage device 200 can include a flexible power wrapper utilizing a sealing material and pouch for the electrolyte-receiving chamber 204.

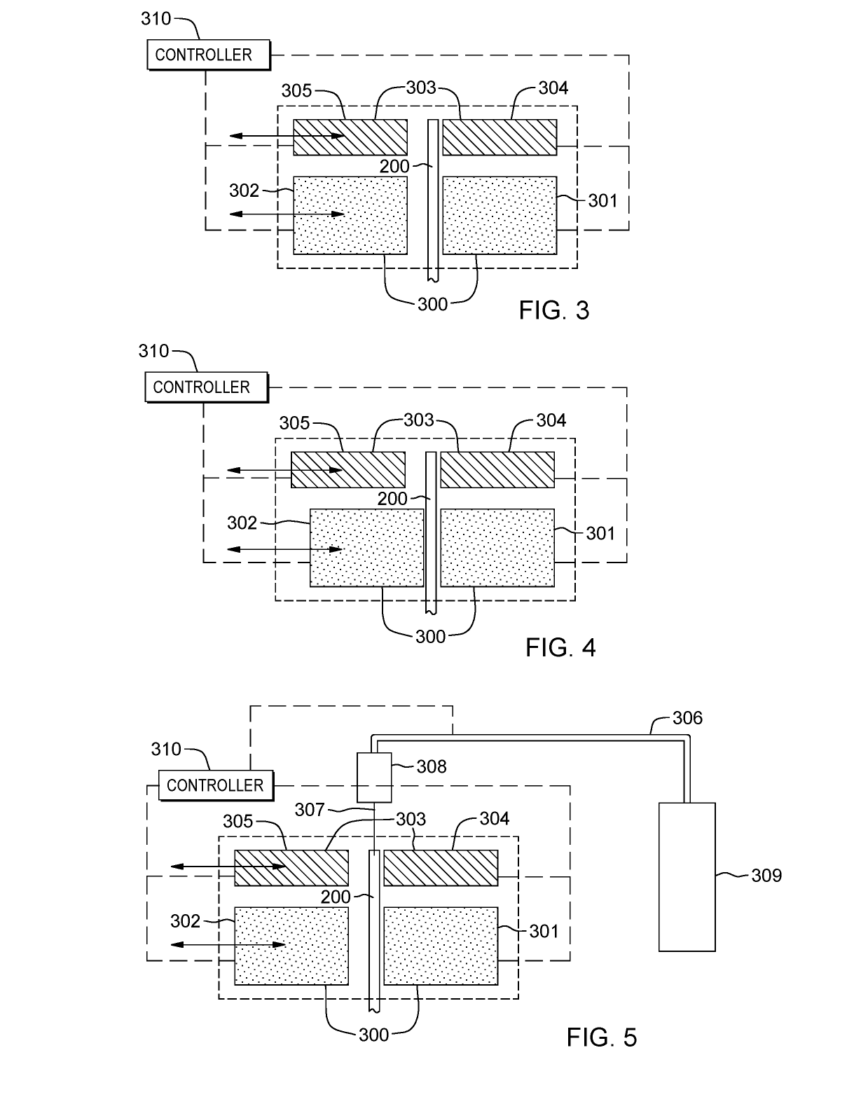

The method 100 of FIG. 1 is illustrated, for instance, in FIGS. 3-7. Turning to FIG. 3, an energy storage device 100 (FIG. 2) is provided. In some embodiments, a set of cooling plates 300 are provided. By way of example, one cooling plate 301 may be stationary for bracing against the energy storage device 100 and one cooling plate 302 may move in order to clamp the energy storage device 100 in place. Also provided are heating clamps 303. Additionally, in some embodiments heating clamp 304 is fixed while heating clamp 305 moves for clamping opening 202 (FIG. 2) closed after filling with an electrolyte solution. The cooling plates 300 and heating clamps 303 may be independently operated in some embodiments. This allows for pressure to be applied individually in order to eliminate inadvertent loss of electrolyte solution when cooling and/or sealing. A controller 310, for instance, a programmable logic controller (PLC) may be utilized to control the movement of cooling plates 300 and heating clamps 303, and may be programmed with (in one embodiment) a user interface connected to a computer. While the controller 310 is shown as being in communication with both cooling plates 300 and both heated clamps 303, it should be understood that one or more of the cooling plates 300 and heated clamps 303 may be stationary and not in communication with the controller 310. For instance, in some embodiments, cooling plate 301 and heated clamp 304 are stationary, and cooling plate 303 and heated clamp 305 are in communication with the controller 310, which moves cooling plate 303 and heated clamp 305 into contact with the energy storage device 200 when necessary.

The cooling plates 300 can be placed in proximity to and moved in contact with the energy storage device 200 or the device moved to be in contact with the cooling plates 300. In some embodiments, the cooling plates 300 may include copper plate with a thermoelectric cooler on one side of the plates, cooled by a liquid coolant. The contact of the cooling plate 300 and the energy storage device 200 can be such that further operations of processing and fabrication will not be impeded. The cooling plates 300 can be actively cooled with temperature regulated media such as but not limited to: glycol, water, refrigerant, and nitrogen, or passively conduct heat from the device via atmospheric exposure. The thermally conductive media can be pushed through or over the cooling plates using pumps, compression, or gravity mechanisms. The cooling plates can include controls to monitor the temperature during operation and adjust to ensure the device and electrolyte are at a temperature for the electrolyte to be stable during the dispensing process as well as processes to finish device construction such as: welding, sealing, and various forms of structural bonding.

As seen in FIG. 3, the cooling plates 300 and heating clamps 303, which are independently operated, are adjacent to one another but spaced apart by a gap of approximately 3 mm to approximately 10 mm, but not varying more than +/−1 mm. The cooling plates 300 are configured to contact the electrolyte-receiving chamber 204 while the heating clamps 303 are configured to contact the opening 202 of the edge 206 of the energy storage device 200 (FIG. 2). This can help eliminate unnecessary heating of the electrolyte. There is also a predetermined gap between cooling plate 301 and cooling plate 302. This gap between cooling plates 300 should be large enough to allow sufficient space for the electrolyte to saturate or nearly saturate the membrane and disperse within the energy storage device 200. It should also be small enough to allow all air in the chamber to be expelled and sufficient cooling of the electrolyte within the electrolyte-receiving chamber 204 to be applied. The distance of this gap can be dependent on the thickness of the energy storage device 200 and its components. Additionally, the heating clamps 303 may be configured so that only the portion wide enough to contact the opening 202 are heated, with insulated areas surrounding the remaining portion. In some embodiments, a ceramic heating unit may be utilized to provide localized heating of the opening 202.

In some embodiments, as depicted in FIG. 4, cooling plate 302 is moved into contact with the electrolyte-receiving chamber prior to filling in order to cool the chamber such that the electrolyte may not volatilize on contact with the material. This precooling can be accomplished by cooling the electrolyte-receiving chamber 204 to between approximately −40° C. and approximately −5° C., in some embodiments to approximately −10° C., by using any now known or later developed means of cooling the cooling plates 300 prior to, during, or after clamping down onto the electrolyte-receiving chamber 204. In one or more embodiments, this can reduce the amount of air trapped in the electrolyte-receiving chamber. The electrolytes used in devices of some embodiments are volatile even at room temperature. Thus, the solvent can begin to evaporate upon injection. Precooling the chamber can reduce or eliminate immediate evaporation of the injected electrolyte.

Turning to FIG. 5, once the electrolyte-receiving chamber 204 (FIG. 2) has been cooled, the cooling plate 302 can be opened and a needle and pump assembly 306 can be used to fill the chamber with electrolyte solution, which can include any now known or later developed electrolyte solution, including but not limited to an ionic liquid of tetra-ethyl ammonium salts with various solvents, for example, propylene carbonate (PC), dimethyl carbonate (DMC), acetonitrile (ACN), or combinations thereof. The controller 310 may also be configured to control, operate, and move the needle and pump assembly 306. For instance, the needle 307 can be inserted through the opening 202 (FIG. 2). A valve 308, which can include a modified solenoid operated valve which reduces the dead volume of electrolyte to, for instance, less than one microliter and can operate between 10 atmospheres (atm) vacuum and 1 atm vacuum without leakage, in connection to a pump 309, can be utilized to fill or partially fill the electrolyte-receiving chamber 204 with the electrolyte solution. The valve 308, or other internal parts of needle and pump assembly 306, may include electro-polished internal parts to avoid the electrolyte solution sticking to any portion of the needle and pump assembly 306, including but not limited to the walls of any component. Once filled, the needle 307 may be removed from the opening 202.

In some embodiments, filling the electrolyte-receiving chamber 204 can include injecting between approximately 20 and approximately 200 microliters of electrolyte, in some embodiments at approximately 1 atm of pressure and in a vacuum of approximately 26 inches of mercury. While the needle and pump assembly 306 described above may be utilized, any now known or later developed method for delivery is envisioned. For instance, filling methods can include a fluid dispensing pump similar to those used in high pressure liquid chromatography (HPLC) applications, syringe pumps, or pressure applied to an electrolyte tank manually or by a machine. In some embodiments utilizing a valve 308, it may be beneficial to reduce the “open” time of the valve to better control delivery of the electrolyte. In these embodiments, a dead volume of less than 10 microliters can be accomplished, and the needle 307 may have a dead volume of less than 2 microliters.

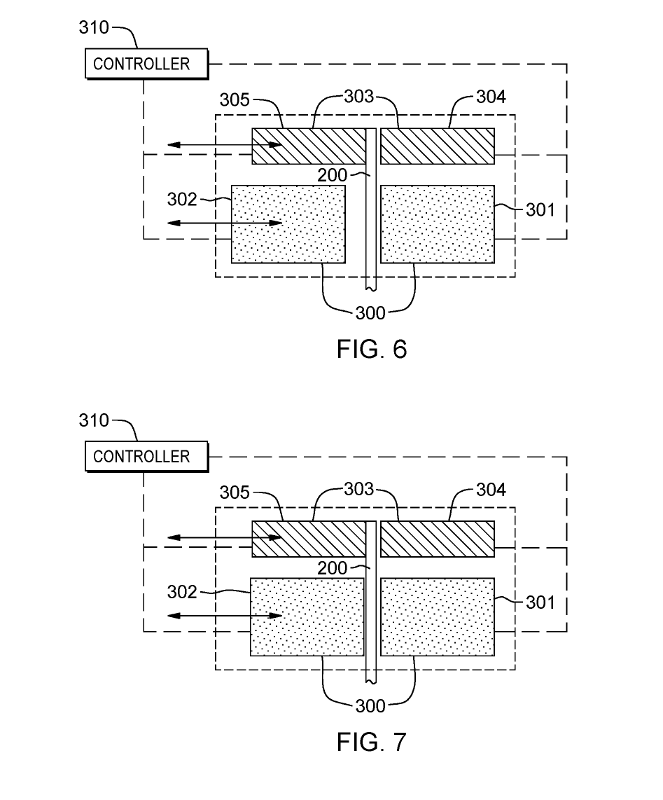

As depicted in FIG. 6, once the electrolyte-receiving chamber 204 (FIG. 2) has been filled with the desired amount of electrolyte solution, heating clamp 305 can clamp down over the opening 204 to reduce any loss of electrolyte upon closing of cooling plate 303. Enough force is applied to keep electrolyte from escaping through opening upon clamping of cooling plate 303. FIG. 7 depicts cooling plate 303 closing on electrolyte-receiving chamber 204. The electrolyte within the electrolyte-receiving chamber 204 may then be cooled to a temperature sufficient to maintain a liquid phase of the electrolyte within the electrolyte-receiving chamber during the heat-sealing.

In some embodiments, the electrolyte is cooled by cooling the cooling plates 300, now in contact with the electrolyte-receiving chamber 204 and cooling the electrolyte to a temperature between approximately −25° C. and approximately −5° C., in some embodiments to a temperature of approximately −10° C. The period for cooling to these temperatures may include between 30 seconds to one hour. In some embodiments, the electrolyte may be agitated during this cooling to ensure proper placement of the electrolyte within the chamber moving it further from the opening. Agitation may occur by jogging the energy storage device, ultrasonic transducers, pinch rollers, or other means of agitating a liquid. In order to get a high capacitance, it can be beneficial for the electrolyte to wet all pores in an electrode. To facilitate this and speed up, agitating, or jogging, of cooling plates 300 may be utilized. Thus, during the hold period, cooling plates, in one embodiment, may be moved backward and brought back to their original position at a certain speed, allowing for the pressure in the sample to vary, thus facilitating electrolyte penetration into pores of electrodes and a separator. Alternately ultrasonic transducer or other mechanical means to vibrate or make rapidly reversing changes in the volume of the sample can achieve this.

Once the electrolyte has reached the desired temperature, heat, pressure, or both, can be applied to the opening through the heated clamps 303 to seal the opening 202. In some embodiments, this includes providing heat and pressure through heated clamps 303 sufficient to seal an edge border. However, in other embodiments the heat-sealing may instead include applying epoxy, pressure sensitive adhesive (PSA), UV curable materials, or any other sealing materials before applying heat and/or pressure. The seal height of the opening may include between 3 mm and 20 mm. In embodiments utilizing heat to seal the heat temperature can include between approximately 160° C. and approximately 240° C. This temperature can include any temperature necessary to seal the chosen means. The heat from the heating clamps 303 is applied substantially only to the opening 202, while other portions of the energy storage device are protected from the heat applied. For instance, the heating clamps 303 may include, in some embodiments, a ceramic heating element with a polished back, and insulating all but the opening from the heat.

Advantageously, by cooling the electrolyte concurrently to heat-sealing, the electrolyte does not substantially evaporate during sealing. Evaporation during sealing allows for vapors to interfere with the seal, and a hermetic seal may not be possible. However, according to some embodiments of the present invention, a hermetic seal is accomplished, or a very low level leakage seal is accomplished. Additionally, the original composition of the electrolyte solution is maintained.

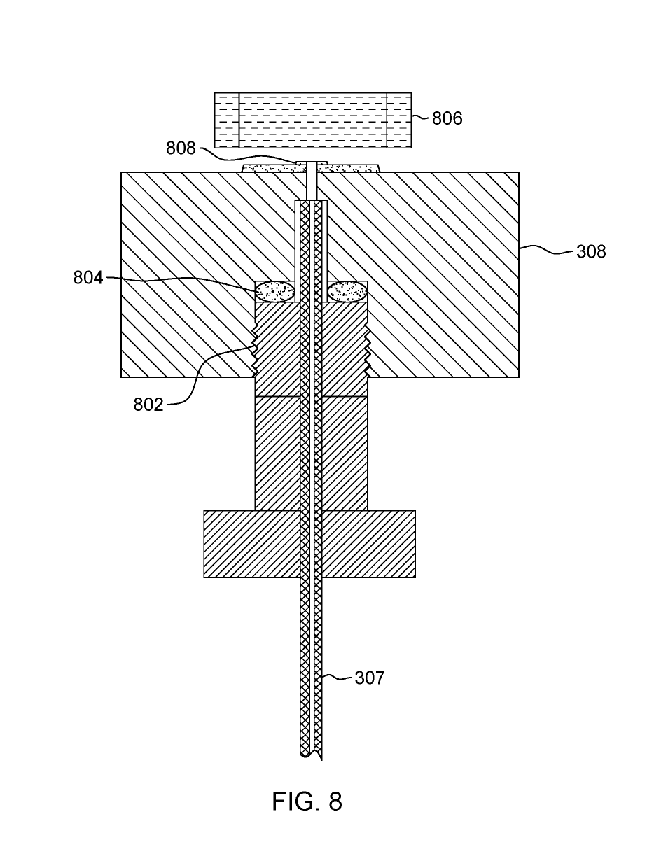

One example of a needle and pump assembly 306 (FIG. 5) is illustrated in more detail in FIG. 8, which depicts a needle 307 extending from a valve 308 including the housing around valve 308. Threading 802 to connect the needle 307 to the valve 308 is included with a needle seal 804. A plunger gland 806 is shown above the valve seal 808 for controlling the application of electrolyte with reduced dead volume, as previously described. Any or all parts of needle and pump assembly 306 may be electro-polished, reducing or negating any electrolyte sticking to any part of the assembly. The needle and pump assembly 306 may be in communication with the controller 310 (FIG. 5), which can automate the processes described herein.

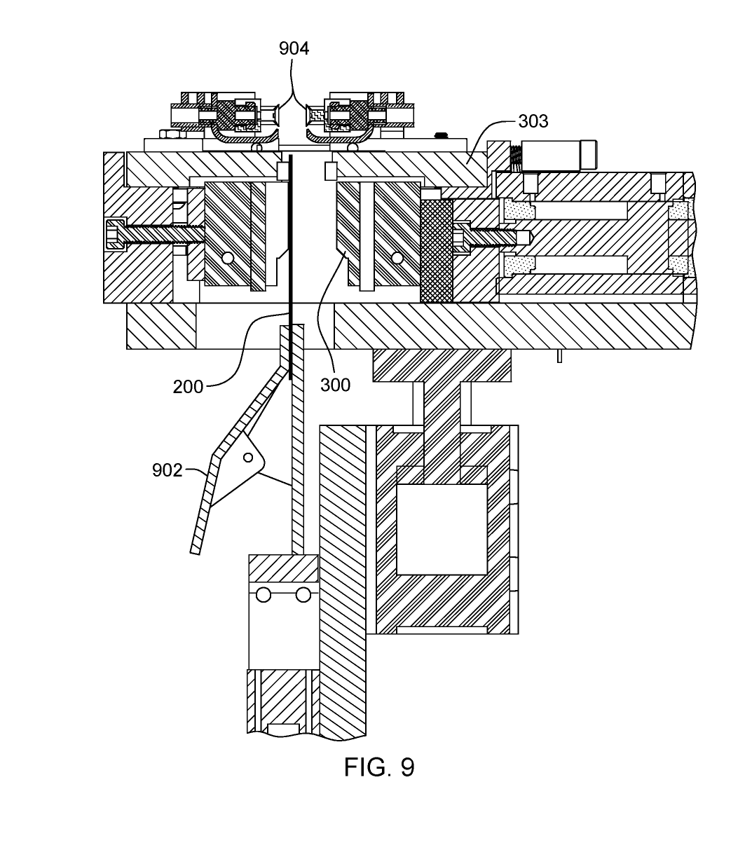

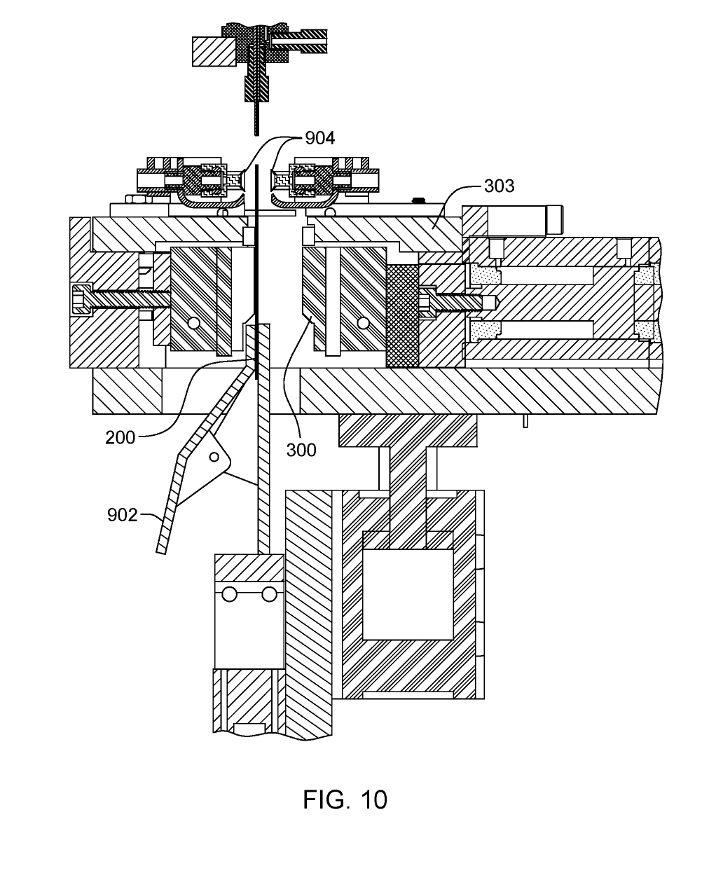

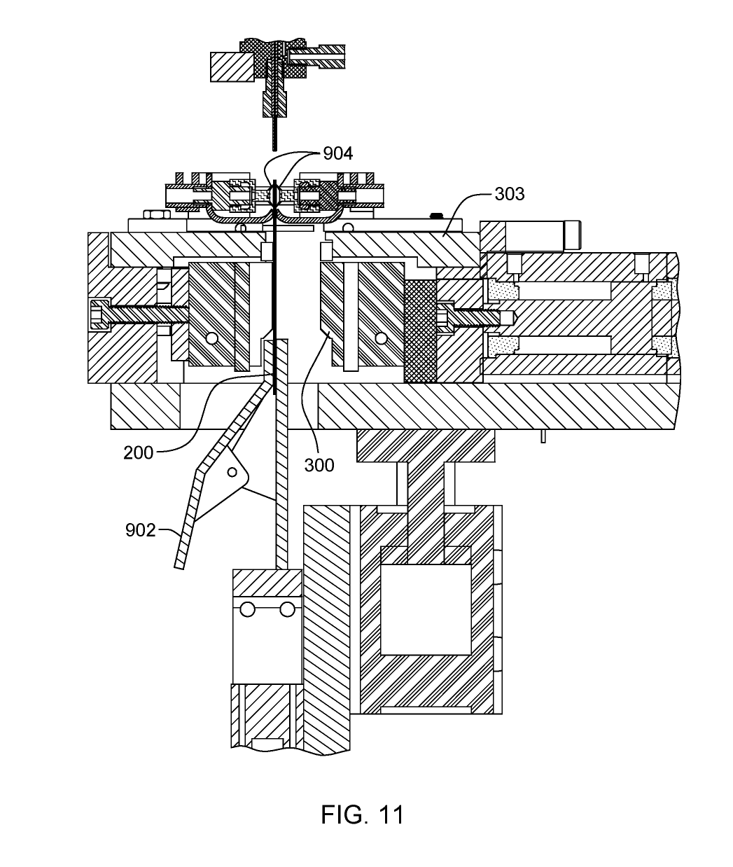

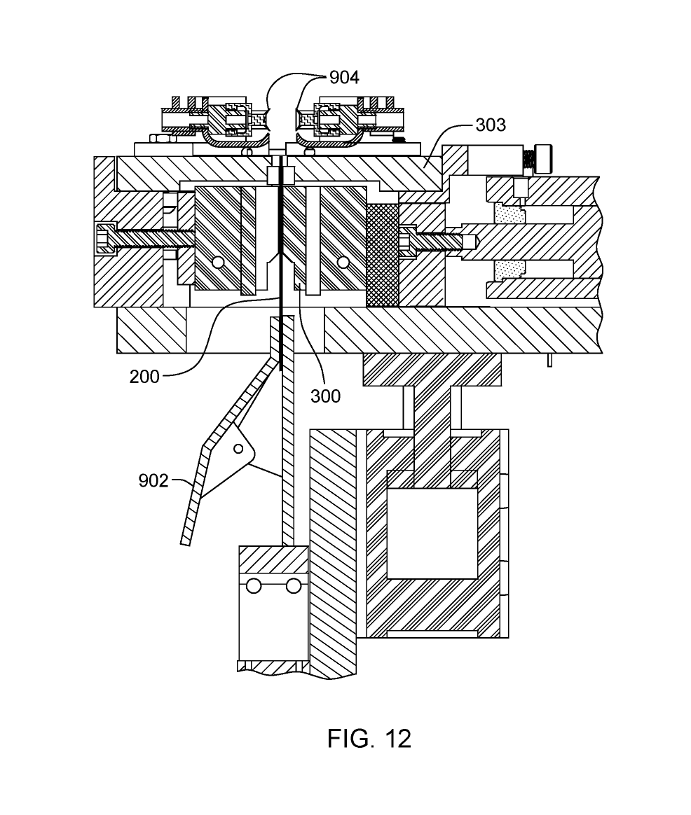

FIGS. 9-12 depict a device for and method of sealing and cooling an energy storage device 200 in more detail and with optional embodiments. For instance, in FIG. 9, an energy storage device 200 is held in place by holder 902. In FIG. 10 the holder 902 lifts the energy storage device into a position to be filled. In FIG. 11 grippers 904 come into contact with opening 202. Grippers 904 can include suction cups, pinchers, or any device capable of separating the material on either side of opening 202. In FIG. 12, the electrolyte-receiving chamber 204 has been filled and the energy storage device 200 has been lowered back to a sealing position by holder 902, which may utilize an actuator for movement. Cooling plates 300 and heated clamps 303 are depicted in a closed position for cooling and heat-sealing, which may be operated by the same type of or different types of actuators, any now known or later developed actuators may be utilized which can act independently of one another.

While certain embodiments of a method and device are disclosed above, additional steps may be utilized or left out based on certain embodiments. Detailed below are a set of additional steps and further details of some steps which may be useful according to some embodiments.

In one detailed embodiment, an energy storage device may be provided into a device as described above. In some embodiments, the device may be enclosed and include a door, which can be closed upon providing the energy storage device. The cooling plates may then be applied to the electrolyte-receiving chamber 204, cooling to a temperature between approximately −40° C. and approximately −5° C., in some embodiments to a temperature of −10° C. A vacuum may then be applied to the device, for instance between approximately −0.5 inches of mercury to approximately −29 inches of mercury, in some embodiments approximately −29 inches of mercury, in order to evacuate the electrolyte-receiving chamber 204. The vacuum may applied for approximately 1 second to approximately 180 seconds, and in some embodiments for 120 seconds. The vacuum may be applied during or after cooling the electrolyte-receiving chamber 204. Following the vacuum, the cooling plates may release the energy storage device 200, which is then moved into a filling position.

Grippers 904 may then be used to separate the material of the opening 202. The needle 307 can then be brought into place and inserted into the opening 202 to a depth between the height of the barrier at the bottom of the opening and the height of the contacts 208. The electrolyte-receiving chamber may be evacuated again prior to filling with the electrolyte. This evacuation may include applying a vacuum of approximately 0.0 inches of mercury to approximately −29.5 inches of mercury, in some embodiments −1.0 inches of mercury. The vacuum may be applied for between 1 second and 20 seconds, and in some embodiments may include 10 seconds.

The electrolyte-receiving chamber 204 may then be filled with electrolyte. In some embodiments, the electrolyte-receiving chamber 204 may be filled only halfway, in which case the next steps are followed. If the electrolyte-receiving chamber 204 is completely filled, the next few steps may be omitted and the method continues at the step of turning off the grippers. In embodiments where the electrolyte-receiving chamber 204 is half filled, the pump 309 injects a predetermined amount of electrolyte using the valve 308. The needle 307 is raised and the grippers are turned off, in these embodiments for a first time. Heated clamps 303 are then closed, but not heated, to temporarily seal the opening 202. The cooling plates 300 are then closed, bringing them into contact with the electrolyte-receiving chamber 204, cooling to the above noted temperatures. In some embodiments the device is then pressurized to ATM. The chamber is cooled for the required amount of time to reach the desired temperature. The cooling plates 300 and heated clamps 303 are both moved to the open positions and the chamber is evacuated again before the next filling.

The opening is then opened again, the needle inserted a second time, and the chamber filled the rest of the way. The grippers are then turned off one last time, or the process is continued in embodiments where the chamber was completely filled the first time. It should be understood that one, two, or any number of repetitions may take place, filling the chamber in as many steps as desired.

Once the grippers are open and the needle has been removed, the energy storage device may be lowered again. The heated clamps are closed first, and then the cooling plates are moved into a closed position. The electrolyte is then cooled as described above to a temperature between approximately −25° C. and approximately −5° C., in some embodiments approximately −10° C. At this point, the electrolyte may also be agitated by any means. Once the desired temperature is reached, heat is applied to the heated clamp in order to seal the opening. Then the cooling plates and heated clamps are removed and the device may be pressurized to room ATM. The door of the device may then be opened and the energy storage device removed for further processing or to be used in any application.

The above described steps may be controlled by a programmable logic controller (PLC) 310 (FIG. 3) or other tangible means. The invention includes the program code stored on tangible, non-transitory storage means.

As noted, provided herein is a method for filling and sealing an energy storage device. The method includes: providing an energy storage device with an opening to an electrolyte-receiving chamber; filling the electrolyte-receiving chamber with an electrolyte; cooling the electrolyte within the electrolyte-receiving chamber; and sealing the opening while cooling the electrolyte within the electrolyte-receiving chamber.

In one or more embodiments, the method further comprises applying one or more cooling plates to the electrolyte-receiving chamber, and the sealing the opening further comprises applying one or more heated clamps to an edge of the energy storage device, adjacent to and spaced apart from, the cooling plates, wherein the cooling plates and the heated clamps move independently of one another.

In one or more embodiments, the method further comprises wherein the cooling the electrolyte within the electrolyte-receiving chamber comprises cooling the electrolyte to a temperature sufficient to maintain a liquid phase of the electrolyte within the electrolyte-receiving chamber during the sealing, and the cooling temperature is between approximately −25° C. and approximately −5° C.

In one or more embodiments, the method further comprises wherein the sealing comprises heating the edge of the energy storage device at the opening to the electrolyte-receiving chamber to a temperature sufficient to seal the opening and volatilize the electrolyte, wherein the temperature is between approximately 160° C. and approximately 240° C.

In one or more embodiments, the method further comprises cooling the electrolyte-receiving chamber with the cooling plates prior to filling the electrolyte-receiving chamber with the electrolyte to a temperature between approximately −40° C. and approximately −5° C.

In one or more embodiments, the method further comprises evacuating the electrolyte-receiving chamber during the cooling of the electrolyte-receiving chamber by applying a vacuum between approximately −0.5 inches of mercury to approximately −29 inches of mercury for approximately 1 second to approximately 180 seconds.

In one or more embodiments, the method further comprises cooling the electrolyte prior to filling the electrolyte-receiving chamber with the electrolyte.

In one or more embodiments, the method further comprises evacuating the electrolyte-receiving chamber prior to filling the electrolyte-receiving chamber with the electrolyte by applying a vacuum of approximately 0.0 inches of mercury to approximately −29.5 inches of mercury for between 1 second and 20 seconds.

In one or more embodiments, the method further comprises agitating the energy storage device during the cooling of the electrolyte within the electrolyte-receiving chamber.

It should be understood that the process steps described are only illustrative. Any combination of features described herein in any order should be understood to be included in the scope of the disclosure. For instance, changing the electrolyte, and thus its vapor pressure and/or viscosity, could change one or more of the parameters of the process, including but not limited to the temperature and time of cooling, the applied vacuum, the time and temperature or pressure of sealing, and any other parameters described. The processes should be understood to include functionally equivalent parameters.

As noted, provided herein is an apparatus for filling and sealing an energy storage device. The apparatus includes: one or more cooling plates for cooling an electrolyte-receiving chamber of the energy storage device; one or more heated clamps for sealing an opening placed near an edge of the energy storage device, adjacent to and spaced apart from the cooling plates, wherein the cooling plates and the heated clamps move independently of one another; and a controller for independently controlling the one or more cooling plates and the one or more heated clamps.

In one or more embodiments, the apparatus further comprises a needle and pump assembly for filling the electrolyte-receiving chamber.

In one or more embodiments, the apparatus further comprises wherein the one or more cooling plates cool the electrolyte by contacting the electrolyte-receiving chamber concurrently to the one or more heated clamps contacting the opening and sealing the opening.

In one or more embodiments, the apparatus further comprises a holder for positioning the energy storage device.

In one or more embodiments, the apparatus further comprises a set of grippers for spreading the opening of the energy storage device prior to filling the electrolyte-receiving chamber.

The present invention may include a device and/or a method, any of which may be configured to perform or facilitate aspects described herein.

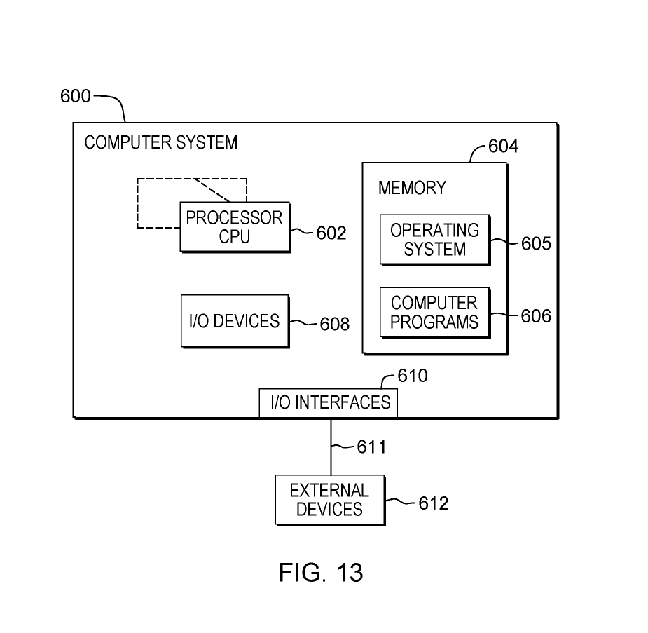

Processes described herein may be performed singly or collectively by one or more computer systems, such as one or more programmable user interface computers. FIG. 13 depicts one example of such a computer system, for instance a controller 310 (FIG. 5), and associated devices to incorporate and/or use aspects described herein. A computer system, which can include a controller, in some embodiments a programmable logic controller (PLC), may also be referred to herein as a data processing device/system, computing device/system/node, or simply a computer. The computer system may be based on one or more of various system architectures and/or instruction set architectures, such as those offered by Intel Corporation (Santa Clara, Calif., USA) or ARM Holdings plc (Cambridge, England, United Kingdom), as examples.

FIG. 13 shows a computer system 600 in communication with external device(s) 310, for instance the apparatus described above, including but not limited to one or more cooling plates 300, on or more heated clamps 303, a needle and pump assembly 306, grippers 904, and a holder 902. Computer system 600 includes one or more processor(s) 602, for instance central processing unit(s) (CPUs). A processor can include functional components used in the execution of instructions, such as functional components to fetch program instructions from locations such as cache or main memory, decode program instructions, and execute program instructions, access memory for instruction execution, and write results of the executed instructions. A processor 602 can also include register(s) to be used by one or more of the functional components. Computer system 600 also includes memory 604, input/output (I/O) devices 608, and I/O interfaces 610, which may be coupled to processor(s) 602 and each other via one or more buses and/or other connections. Bus connections represent one or more of any of several types of bus structures, including a memory bus or memory controller, a peripheral bus, an accelerated graphics port, and a processor or local bus using any of a variety of bus architectures. By way of example, and not limitation, such architectures include the Industry Standard Architecture (ISA), the Micro Channel Architecture (MCA), the Enhanced ISA (EISA), the Video Electronics Standards Association (VESA) local bus, and the Peripheral Component Interconnect (PCI).

Memory 604 can be or include main or system memory (e.g. Random Access Memory) used in the execution of program instructions, storage device(s) such as hard drive(s), flash media, or optical media as examples, and/or cache memory, as examples. Memory 604 can include, for instance, a cache, such as a shared cache, which may be coupled to local caches (examples include L1 cache, L2 cache, etc.) of processor(s) 602. Additionally, memory 604 may be or include at least one computer program product having a set (e.g., at least one) of program modules, instructions, code or the like that is/are configured to carry out functions of embodiments described herein when executed by one or more processors.

Memory 604 can store an operating system 605 and other computer programs 606, such as one or more computer programs/applications that execute to perform aspects described herein. Specifically, programs/applications can include computer readable program instructions that may be configured to carry out functions of embodiments of aspects described herein.

Examples of I/O devices 608 include but are not limited to microphones, speakers, Global Positioning System (GPS) devices, cameras, lights, accelerometers, gyroscopes, magnetometers, sensor devices configured to sense light, proximity, heart rate, body and/or ambient temperature, blood pressure, and/or skin resistance, and activity monitors. An I/O device may be incorporated into the computer system as shown, though in some embodiments an I/O device may be regarded as an external device (612) coupled to the computer system through one or more I/O interfaces 610.

Computer system 600 may communicate with one or more external devices 612 via one or more I/O interfaces 610. Example external devices include a keyboard, a pointing device, a display, and/or any other devices that enable a user to interact with computer system 600. Other example external devices include any device that enables computer system 600 to communicate with one or more other computing systems or peripheral devices such as a printer. A network interface/adapter is an example I/O interface that enables computer system 600 to communicate with one or more networks, such as a local area network (LAN), a general wide area network (WAN), and/or a public network (e.g., the Internet), providing communication with other computing devices or systems, storage devices, or the like. Ethernet-based (such as Wi-Fi) interfaces and Bluetooth® adapters are just examples of the currently available types of network adapters used in computer systems (BLUETOOTH is a registered trademark of Bluetooth SIG, Inc., Kirkland, Wash., U.S.A.).

The communication between I/O interfaces 610 and external devices 612 can occur across wired and/or wireless communications link(s) 611, such as Ethernet-based wired or wireless connections. Example wireless connections include cellular, Wi-Fi, Bluetooth®, proximity-based, near-field, or other types of wireless connections. More generally, communications link(s) 611 may be any appropriate wireless and/or wired communication link(s) for communicating data.

Particular external device(s) 612 may include one or more data storage devices, which may store one or more programs, one or more computer readable program instructions, and/or data, etc. Computer system 600 may include and/or be coupled to and in communication with (e.g. as an external device of the computer system) removable/non-removable, volatile/non-volatile computer system storage media. For example, it may include and/or be coupled to a non-removable, non-volatile magnetic media (typically called a “hard drive”), a magnetic disk drive for reading from and writing to a removable, non-volatile magnetic disk (e.g., a “floppy disk”), and/or an optical disk drive for reading from or writing to a removable, non-volatile optical disk, such as a CD-ROM, DVD-ROM or other optical media.

Computer system 600 may be operational with numerous other general purpose or special purpose computing system environments or configurations. Computer system 600 may take any of various forms, well-known examples of which include, but are not limited to, personal computer (PC) system(s), server computer system(s), such as messaging server(s), thin client(s), thick client(s), workstation(s), laptop(s), handheld device(s), mobile device(s)/computer(s) such as smartphone(s), tablet(s), and wearable device(s), multiprocessor system(s), microprocessor-based system(s), telephony device(s), network appliance(s) (such as edge appliance(s)), virtualization device(s), storage controller(s), set top box(es), programmable consumer electronic(s), network PC(s), minicomputer system(s), mainframe computer system(s), and distributed cloud computing environment(s) that include any of the above systems or devices, and the like.

The present invention may be a system, a method, and/or a computer program product, any of which may be configured to perform or facilitate aspects described herein.

In some embodiments, aspects of the present invention may take the form of a computer program product, which may be embodied as computer readable medium(s). A computer readable medium may be a tangible storage device/medium having computer readable program code/instructions stored thereon. Example computer readable medium(s) include, but are not limited to, electronic, magnetic, optical, or semiconductor storage devices or systems, or any combination of the foregoing. Example embodiments of a computer readable medium include a hard drive or other mass-storage device, an electrical connection having wires, random access memory (RAM), read-only memory (ROM), erasable-programmable read-only memory such as EPROM or flash memory, an optical fiber, a portable computer disk/diskette, such as a compact disc read-only memory (CD-ROM) or Digital Versatile Disc (DVD), an optical storage device, a magnetic storage device, an apparatus according to embodiments above, or any combination of the foregoing. The computer readable medium may be readable by a processor, processing unit, or the like, to obtain data (e.g. instructions) from the medium for execution. In a particular example, a computer program product is or includes one or more computer readable media that includes/stores computer readable program code to provide and facilitate one or more aspects described herein.

As noted, program instruction contained or stored in/on a computer readable medium can be obtained and executed by any of various suitable components such as a processor of a computer system to cause the computer system to behave and function in a particular manner. Such program instructions for carrying out operations to perform, achieve, or facilitate aspects described herein may be written in, or compiled from code written in, any desired programming language. In some embodiments, such programming language includes object-oriented and/or procedural programming languages such as C, C++, C#, Java, etc.

Program code can include one or more program instructions obtained for execution by one or more processors. Computer program instructions may be provided to one or more processors of, e.g., one or more computer systems, to produce a machine, such that the program instructions, when executed by the one or more processors, perform, achieve, or facilitate aspects of the present invention, such as actions or functions described in flowcharts and/or block diagrams described herein. Thus, each block, or combinations of blocks, of the flowchart illustrations and/or block diagrams depicted and described herein can be implemented, in some embodiments, by computer program instructions.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description, but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A method comprising:
providing an energy storage device with an opening to an electrolyte-receiving chamber;
filling the electrolyte-receiving chamber with an electrolyte;
cooling the electrolyte within the electrolyte-receiving chamber; and
sealing the opening while cooling the electrolyte within the electrolyte-receiving chamber.

2. The method of claim 1 wherein the cooling the electrolyte within the electrolyte-receiving chamber comprises applying one or more cooling plates to the electrolyte-receiving chamber, and wherein the sealing the opening comprises applying one or more heated clamps to an edge of the energy storage device, adjacent to and spaced apart from the cooling plates, wherein the cooling plates and the heated clamps move independently of one another.

3. The method of claim 2, wherein the cooling the electrolyte within the electrolyte-receiving chamber comprises cooling the electrolyte to a temperature sufficient to maintain a liquid phase of the electrolyte within the electrolyte-receiving chamber during the sealing.

4. The method of claim 3, wherein the temperature is between approximately −25° C. and approximately −5° C.

5. The method of claim 2, wherein the sealing comprises heating the edge of the energy storage device at the opening to the electrolyte-receiving chamber to a temperature sufficient to seal the opening and volatilize the electrolyte, wherein the temperature is between approximately 160° C. and approximately 240° C.

6. The method of claim 2, further comprising cooling the electrolyte-receiving chamber with the cooling plates prior to filling the electrolyte-receiving chamber with the electrolyte.

7. The method of claim 6, wherein the cooling comprises cooling the electrolyte-receiving chamber to a temperature between approximately −40° C. and approximately −5° C.

8. The method of claim 6, further comprising evacuating the electrolyte-receiving chamber during the cooling of the electrolyte-receiving chamber.

9. The method of claim 8, wherein the evacuating comprises applying a vacuum between approximately −0.5 inches of mercury to approximately −29 inches of mercury.

10. The method of claim 9, wherein the vacuum is applied for approximately 1 second to approximately 180 seconds.

11. The method of claim 2, further comprising cooling the electrolyte prior to filling the electrolyte-receiving chamber with the electrolyte.

12. The method of claim 2, further comprising evacuating the electrolyte-receiving chamber prior to filling the electrolyte-receiving chamber with the electrolyte.

13. The method of claim 12 wherein the evacuating the electrolyte-receiving chamber prior to filling with the electrolyte comprises applying a vacuum of approximately 0.0 inches of mercury to approximately −29.5 inches of mercury.

14. The method of claim 13, wherein the vacuum is applied for between 1 second and 20 seconds.

15. The method of claim 1, further comprising:
agitating the energy storage device during the cooling of the electrolyte within the electrolyte-receiving chamber.

16. An apparatus for filing and sealing an energy storage device, the apparatus comprising:
one or more cooling plates for cooling an electrolyte-receiving chamber of the energy storage device;
one or more clamps for sealing an opening placed near an edge of the energy storage device, adjacent to and spaced apart from the cooling plates, wherein the one or more cooling plates and the one or more clamps move independently of one another; and
a controller for independently controlling the one or more cooling plates and the one or more clamps, wherein the controller facilitates sealing the opening while cooling an electrolyte within the electrolyte-receiving chamber.

17. The apparatus of claim 16, further comprising a needle and pump assembly for filling the electrolyte-receiving chamber with the electrolyte.

18. The apparatus of claim 16, wherein the one or more cooling plates cool the electrolyte by cooling the electrolyte-receiving chamber concurrently to the one or more clamps contacting the opening and heat and/or pressure-sealing the opening.

19. The apparatus of claim 16, further comprising a holder for positioning the energy storage device.

20. The apparatus of claim 16, further comprising a set of grippers for spreading the opening of the energy storage device prior to a filling of the electrolyte-receiving chamber.
